(19) United States
(12) Patent Application Publication
(10) Pub. No.: US 2022/0212788 A1
(43) Pub. Date: Jul. 7, 2022

(54) SOLAR UNMANNED AIRCRAFT

(71) Applicant: Chiu-Shia Fen, Hsinchu County (TW)

(72) Inventor: Chiu-Shia Fen, Hsinchu County (TW)

(21) Appl. No.: 17/141,801

(22) Filed: Jan. 5, 2021

(51) Int. Cl. B64C 39/02; B60L 8/00; B64C 11/00; B64C 9/02; B64C 39/08; B64C 5/02; B64D 27/24; B60L 50/60; B64C 25/32; B64F 1/02; G05D 1/08

(52) U.S. Cl. CPC B64C 39/024; B64C 2201/182; B64C 11/00; B64C 9/02; B64C 39/08; B64C 5/02; B64D 27/24; B60L 50/66; B64C 25/32; B64F 1/027; G05D 1/0808; B64C 2201/021; B64D 2211/00; B60L 2200/10; B64C 2201/042; B64C 2201/165; B60L 8/003

(57) ABSTRACT

A solar unmanned aircraft is disclosed. The aircraft includes a first body, a second body, a main wing, a tail wing and at least four vertical control wings. The at least four control wings are all located below the main wing and the tail wing so that an upper surface of the main wing and tail wing can massively be installed with solar panels. Each of the vertical control wings has a fixed wing and a rudder. The rudder can rotate with respect to the fixed wing to control the attitude and motion of the solar unmanned aircraft.

### BACKGROUND OF THE INVENTION

### 1. Field of the Invention

The present invention relates to a solar unmanned aircraft, and more particularly to a solar unmanned aircraft having vertical control wings.

### 2. Description of Related Art

A general aircraft has a main wing for providing buoyancy force and tail wing as a stabilizing wing for providing horizontal stabilization, and also has some control wings located above the main wing and the tail wing. When the control wings are utilized on a solar unmanned aircraft, the weight of the solar unmanned aircraft is increased. Besides, the control wings located above the main wing and the tail wing will also decrease an area for installing solar battery. In addition, a generally aircraft also has a landing gear for taking off and landing of the aircraft. The landing gear also increases the weight of the unmanned aircraft such that a sailing distance of the unmanned aircraft is greatly decreased.

Therefore, how to improve the current technology and decreasing the weight of the solar unmanned aircraft, and decreasing the control wings to provide more area for installing solar panel is a challenging research subject that needs to be improved urgently.

### SUMMARY OF THE INVENTION

The purpose of the present invention is to provide a solar unmanned aircraft to decrease weight and control wings, and increase an installation area of the solar panels.

In order to solve the above-mentioned technical problem, a technical solution provided by the present invention is: a solar unmanned aircraft comprises a first body having a front end and a rear end; a second body having a front end and a rear end; a main wing having an upper surface and a lower surface, wherein the upper surface of the main wing is installed with solar panels, and the lower surface of the main wing is connected with the first body and the second body; a tail wing having an upper surface and a lower surface, wherein the upper surface of the tail wing is installed with solar panels, and the lower surface of the tail wing is connected with the first body and the second body; a first vertical control wing disposed below the main wing and having a first fixed wing and a first rudder; a second vertical control wing disposed below the main wing and having a second fixed wing and a second rudder; a third vertical control wing disposed below the tail wing and having a third fixed wing and a third rudder; a fourth vertical control wing disposed below the tail wing and having a fourth fixed wing and a fourth rudder; a first propeller fixed at the front end of the first body or the rear end of the first body; and a second propeller fixed at the front end of the second body or the rear end of the second body; wherein, the main wing is disposed between the front ends of the first body and the second body, and the tail wing is disposed between the rear ends of the first body and the second body, wherein, the first rudder, the second rudder, the third rudder and the fourth rudder are respectively capable of rotating with respect to the first fixed wing, the second fixed wing, the third fixed wing and the fourth fixed wing so as to control the solar unmanned aircraft to yaw, roll, reduce speed, pitch up or dive.

Wherein at least one of the first vertical control wing, the second vertical control wing, the third vertical control wing and the fourth vertical control wing is connected with the first body or the second body.

Wherein the first vertical control wing is connected with the first body and corresponding to a connection portion of the main wing and the first body, the second vertical control wing is connected with the second body and corresponding to a connection portion of the main wing and the second body, the third vertical control wing is connected with the first body and corresponding to a connection portion of the tail wing and the first body, and the fourth vertical control wing is connected with the second body and corresponding to a connection portion of the tail wing and the second body.

Wherein at least one of the first vertical control wing, the second vertical control wing, the third vertical control wing and the fourth vertical control wing is directly connected with the main wing or the tail wing.

Wherein an end terminal of at least one of the first vertical control wing, the second vertical control wing, the third vertical control wing and the fourth vertical control wing is installed with a sleeve.

Wherein when the solar unmanned aircraft is yawing, the first rudder is in parallel with the first body, the second rudder is in parallel with the second body, the third rudder and the fourth rudder are rotated together clockwise or counterclockwise with a same angle, and respectively form an included angle with the first body and the second body in order to generate a yaw moment.

Wherein when the aircraft is reducing the speed or reducing lift force, the first rudder is rotated counterclockwise and forms an included angle with the first body, the second rudder is rotated clockwise and forms an included angle with the second body, the third rudder is rotated clockwise and forms an included angle with the first body, and the fourth rudder is rotated counterclockwise and forms an included angle with the second body so that through the first rudder and the second rudder, a spoiling effect is generated, and through the third rudder and the fourth rudder, direction of the aircraft is controlled and pressing the head of the aircraft.

Wherein when the head of the aircraft is diving, the first rudder is in parallel with the first body, the second rudder is in parallel with the second body, the third rudder is rotated clockwise and forms an included angle with the first body, the fourth rudder is rotated counterclockwise and forms an included angle with the second body such that a dive moment is generated; when the head of the aircraft is pitching up, the third rudder and the fourth rudder are respectively in parallel with the first body and the second body, the first rudder and the second rudder are rotated with a same angle in opposite directions in order to respectively form an included angle with the first body and the second body, reducing airflow speed under the main wing, so as to generate an upward moment.

Wherein when t the unmanned aircraft performing an axially rolling, the first rudder is rotated counterclockwise or clockwise to form an included angle with the first body, the third rudder is rotated clockwise or counterclockwise in opposite to the first rudder of roughly the same angle, the second rudder is in parallel with the second body, the fourth rudder is in parallel with the second body, to generate a roll moment to life up the first body with respective to the second body.

Wherein the tail wing is capable of providing a horizontal stabilization and providing a lift force to sustain the motor and tail weight respect the gravity center of the aircraft, and using the lift force to generate a pitching control moment.

Wherein an internal space of the main wing and the tail wing is installed with a charge and discharge rechargeable battery as a power storage source of the aircraft.

Wherein the first vertical control wing, the second vertical control wing, the third vertical control wing and the fourth vertical control wing are used as a landing gear of the aircraft.

wherein the first propeller fixed at the rear end of the first body; and the second propeller fixed at the rear end of the second body, while lading the aircraft can have some speed and be captured by a prepared net, so as to avoid long runway and to be safe for the retry of landing.

Accordingly, through disposing the first vertical control wing, the second vertical control wing, the third vertical control wing and the fourth vertical control wing below the main wing and the tail wing, the upper surface of the main wing and the tail wing can be massively installed with solar panels in order to increase an area for installing the solar panels such that the solar unmanned aircraft can stay in the air for a longer time comparing to the conventional art. Besides, using the first rudder, the second rudder, the third rudder and the fourth rudder to respectively rotate with respect to the first fixed wing, the second fixed wing, the third fixed wing and the fourth fixed wing, the solar unmanned aircraft of the present invention can perform any kind of flight motion.

### BRIEF DESCRIPTION OF THE DRAWINGS

FIG. 1 is a schematic diagram of the solar unmanned aircraft having vertical control wings according to the present invention;

FIG. 2 is schematic diagram of the position of the control wings when yawing according to the present invention;

FIG. 3 is schematic diagram of the position of the control wings when landing according to the present invention;

FIG. 4 is schematic diagram of the position of the control wings when diving according to the present invention;

FIG. 5 is schematic diagram of the position of the control wings when pitching up according to the present invention; and

FIG. 6 is schematic diagram of the position of the control wings when rolling according to the present invention.

### DETAILED DESCRIPTION OF THE PREFERRED EMBODIMENT

The following content combines the figures and the embodiments for detail description of the present invention.

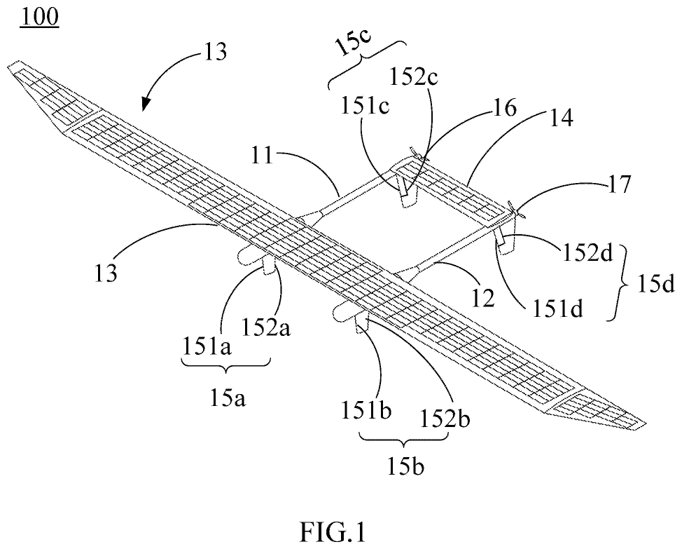

With reference to FIG. 1, FIG. 1 is a solar unmanned aircraft according to the present invention. The solar unmanned aircraft 100 of the present invention includes a first body 11, a second body 12, a main wing 13, a tail wing 14, a first vertical control wing 15a, a second vertical control wing 15b, a third vertical control wing 15c, a fourth vertical control wing 15d, a first propeller 16 and a second propeller 17.

The first body 11 and the second body 12 are parallel. The first propeller 16 is located at a rear end of the first body 11, and the second propeller 17 is located at a rear end of the second body 12. The main wing 13 is disposed between the front ends and rear ends of the first body 11 and the second body 12. The tail wing is connected between the rear ends of the first body 11 and the second body 12. Wherein, a width of the main wing 13 is wider than a width of the tail wing 14.

An upper surface of the main wing 13 is installed with solar panels for providing the power when the solar unmanned aircraft flies. A lower surface of the main wing 13 is connected with the first body 11 and the second body 12. The lower surface of the main wing 13 can also directly connect with the first vertical control wing 15a and/or the second vertical control wing 15b.

An upper surface of the tail wing 14 is installed with solar panels for providing the power of the solar unmanned aircraft when flying. A lower surface of the tail wing can also directly connect with the third vertical control wing 15c and/or the fourth vertical control wing 15d. The tail wing 14 can generate a lifting force as the main wing 13, and using the lifting force to generate a pitch control moment with respect to the center of gravity of the aircraft.

The first vertical control wing 15a is disposed below the main wing 13 and the first body 11 so as to be adjacent to the lower surface of the main wing 13. The first vertical control wing 15a is also corresponding to a connection portion of the main wing 13 and the first body 11. The first vertical control wing 15a has a first fixed wing 151a and a first rudder 152a. The first fixed wing 151a is fixed to the first body 11. The first rudder 152a is fixed to the first fixed wing 151a and capable of rotating with respect to the first fixed wing 151a. Wherein, the first vertical control wing 15a can also locate below the main wing 13 or the first body 11, and the present invention is not limited. Besides, the first vertical control wing 15a has a top terminal and an end terminal. The top terminal is connected with the main wing 13 or the first body 11, and the end terminal of the first vertical control wing 15a forms a free end.

The second vertical control wing 15b is disposed below the main wing 13 and the second body 12 so as to be adjacent to the lower surface of the main wing 13. The second vertical control wing 15b is also corresponding to a connection portion of the main wing 13 and the second body 12. In other words, the second vertical control wing 15b and the first vertical control wing 15a are located at a same side of the main wing 13. The second vertical control wing 15b has a second fixed wing 151b and a second rudder 152b. The second fixed wing 151b is fixed to the second body 12. The second rudder 152b is fixed to the second fixed wing 151b and capable of rotating with respect to the second fixed wing 151b. Wherein, the second vertical control wing 15b can also locate below the main wing 13 or the second body 12, and the present invention is not limited. Besides, the second vertical control wing 15b has a top terminal and an end terminal. The top terminal is connected with the main wing 13 or the second body 12, and the end terminal of the second vertical control wing 15b forms a free end.

The third vertical control wing 15c is disposed below the tail wing 14 and the first body 11 so as to be adjacent to the lower surface of the tail wing 13. The third vertical control wing 15c is also corresponding to a connection portion of the tail wing 14 and the first body 11. The third vertical control wing 15c has a third fixed wing 151c and a third rudder 152c. The third fixed wing 151c is fixed to the first body 11. The third rudder 152c is fixed to the third fixed wing 151c and capable of rotating with respect to the third fixed wing 151c. Wherein, the third vertical control wing 15c can also locate below the tail wing 14 or the first body 11, and the present invention is not limited. Besides, the third vertical control wing 15c has a top terminal and an end terminal. The top terminal is connected with the tail wing 14 or the first body 11, and the end terminal of the third vertical control wing 15c forms a free end.

The fourth vertical control wing 15d is disposed below the tail wing 14 and the second body 12. The fourth vertical control wing 15d is also corresponding to a connection portion of the tail wing 14 and the second body 12. In other words, the fourth vertical control wing 15d and the third vertical control wing 15c are located at a same side of the tail wing 13. The fourth vertical control wing 15d has a fourth fixed wing 151d and a fourth rudder 152d. The fourth fixed wing 151d is fixed to the second body 12. The fourth rudder 152d is fixed to the fourth fixed wing 151d and capable of rotating with respect to the fourth fixed wing 151d. Wherein, the fourth vertical control wing 15d can also locate below the tail wing 14 or the second body 12, and the present invention is not limited. Besides, the fourth vertical control wing 15d has a top terminal and an end terminal. The top terminal is connected with the tail wing 13 or the second body 12, and the end terminal of the fourth vertical control wing 15d forms a free end.

Accordingly, through the first vertical control wing 15a, the second vertical control wing 15, the third vertical control wing 15c and the fourth vertical control wing 15d, when the unmanned aircraft of the present invention is on the ground, the unmanned aircraft can be stably supported. Besides, when the unmanned aircraft is landing, the above four vertical control wings can be used as a landing gear such that an additional landing gear is not required. Specifically, end terminals of the first fixed wing 151a, the second fixed wing 151b, the third fixed wing 151c and the fourth fixed wing 151d can be installed with sleeves (not shown in the figures). The sleeves are made of rubber so that the friction when landing and sliding is reduced.

The first rudder 152a, the second rudder 152b, the third rudder and the fourth rudder 152d can rotate with respect to the first fixed wing 151a, the second fixed wing 151b, the third fixed wing 151c and the fourth fixed wing 151d in order to control the direction of the aircraft, specifically descripting as following paragraph.

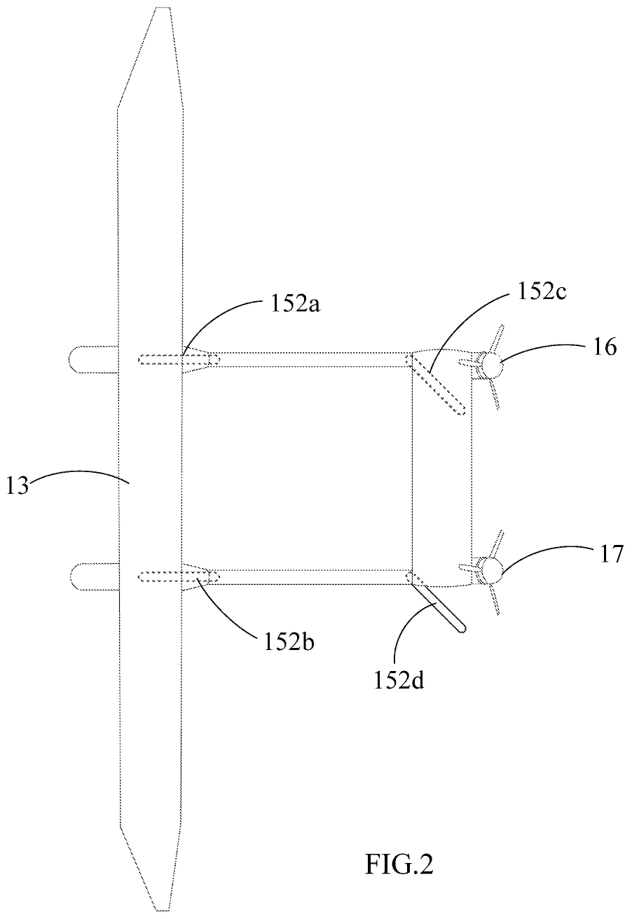

With reference to FIG. 2, when the aircraft intends to rotate, that is also called yawing, the first rudder 152a is in parallel with the first body 11, the second rudder 152b is in parallel with the second body 12. The third ruder 152c is rotated clockwise or counterclockwise and forms an included angle with the first body 11. The fourth rudder 152d is rotated clockwise or counterclockwise and forms an included angle with the first body 12. Preferably, the third rudder 152c and the fourth rudder 152d are rotated together with a same angle, and respectively form an included angle with the first body 11 and the second body 12 in order to generate a yaw moment.

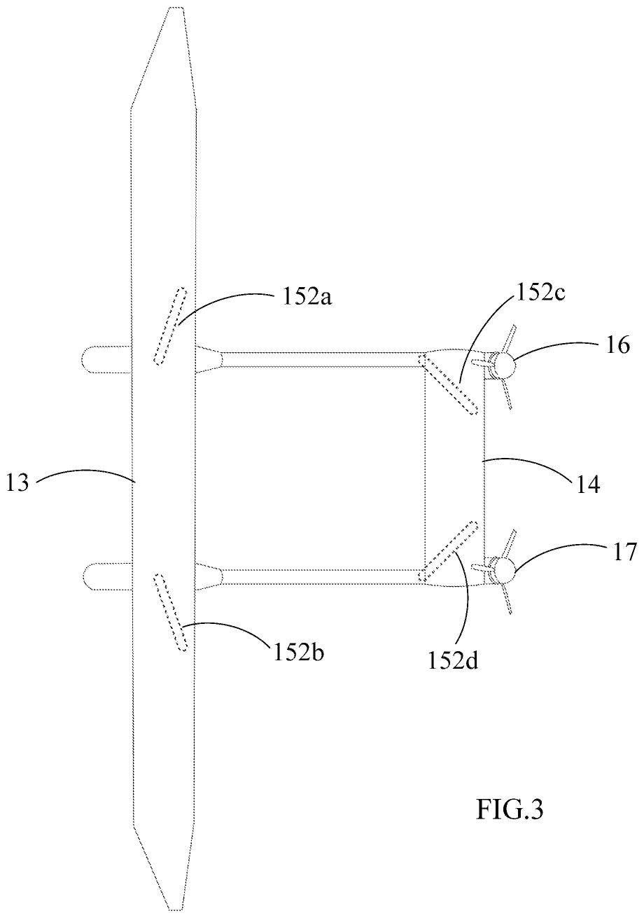

With reference to FIG. 3, when the aircraft 100 is landing, and reducing the speed through brake or reducing lift force is required, the first rudder 152a is rotated counterclockwise and forms an included angle with the first body 11, the second rudder 152b is rotated clockwise and forms an included angle with the second body 12, the third rudder 152c is rotated clockwise and forms an included angle with the first body 11, and the fourth rudder 152d is rotated counterclockwise and forms an included angle with the second body 12. Through the first rudder 152a and the second rudder 152b, a spoiling effect is generated. Besides, through the third rudder 152c and the fourth rudder 152d, direction of the aircraft is controlled and pressing the head of the aircraft.

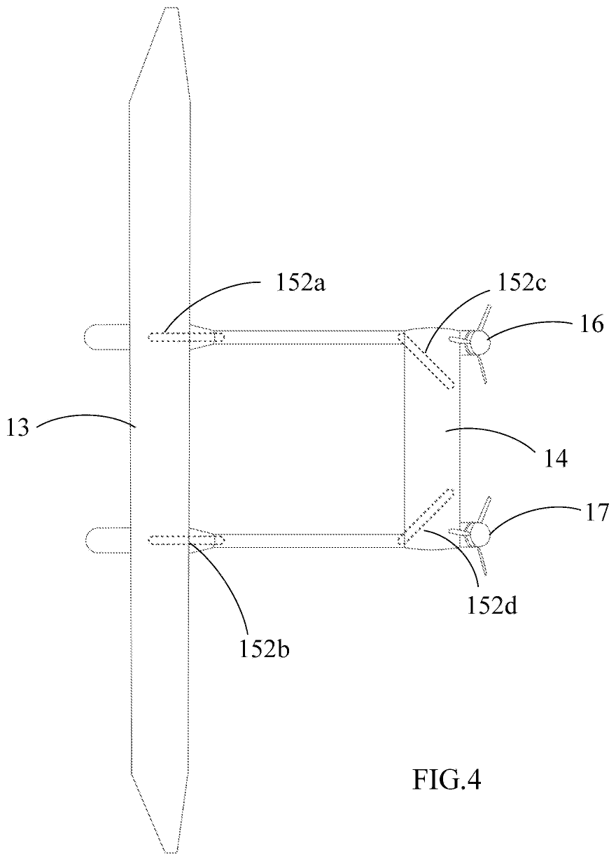

With reference to FIG. 4, when the head of the aircraft 100 intends to pitch up or dive. Wherein, when the head of the aircraft intends to dive, the first rudder 152a is in parallel with the first body 11, the second rudder 152b is in parallel with the second body 12. The third rudder 152c is rotated clockwise and forms an included angle with the first body 11, the fourth rudder 152d is rotated counterclockwise and forms an included angle with the second body 12 such that a dive moment is generated. The head of the aircraft dives by increasing the lift force of the tail wing through the third rudder 152c and the fourth rudder 152d.

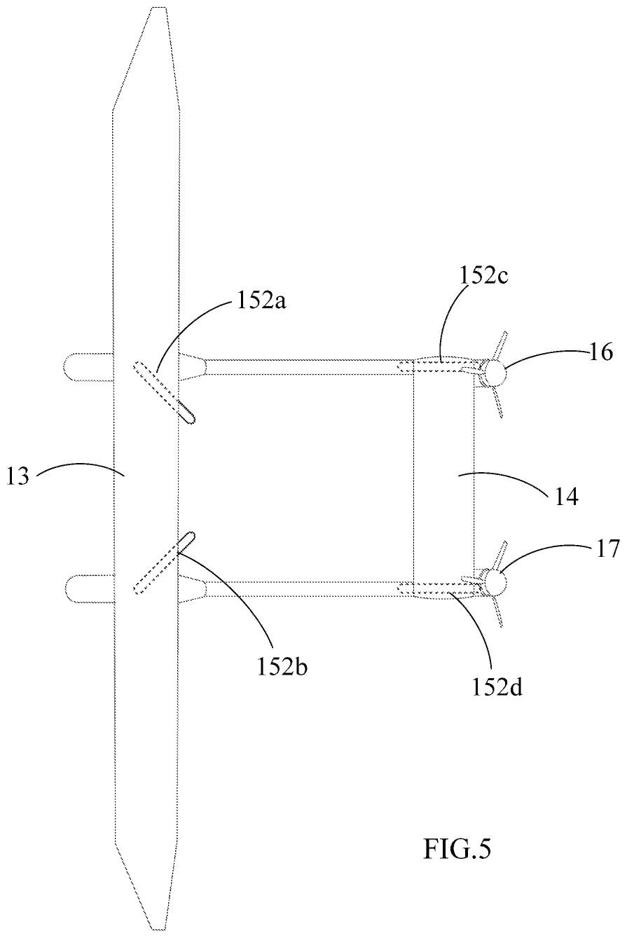

With reference to FIG. 5, when the head of the aircraft intends to pitch up, the third rudder 152c and the fourth rudder 152d are respectively in parallel with the first body 11 and the second body 12. The first rudder 152a and the second rudder 152b are rotated with a same angle in opposite directions in order to respectively form an included angle with the first body 11 and the second body 12, reducing airflow speed under the main wing, so as to generate an upward moment.

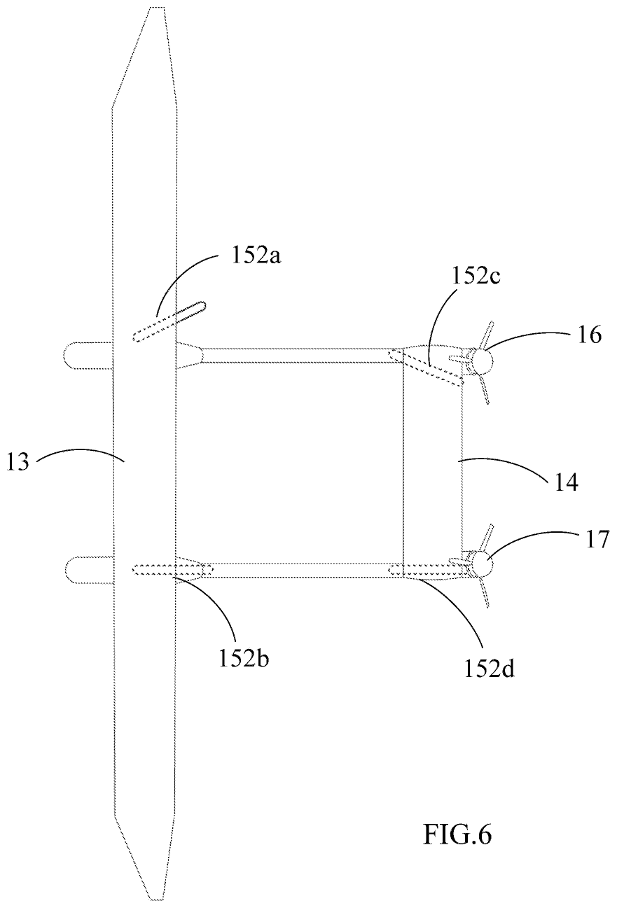

With reference to FIG. 6, when the unmanned aircraft intends to perform an axially rolling, the first rudder 152a is rotated counterclockwise or clockwise to form an included angle with the first body 11, the third rudder 152c is rotated clockwise or counterclockwise in opposite to the first rudder 152a with roughly the same angle, the second rudder 152b is in parallel with the second body 12, the fourth rudder 152d is in parallel with the second body 12, to generate a roll moment to life up the first body 11 with respective to the second body 12 such that the solar unmanned aircraft 100 can perform an axially rolling. Accordingly, the lift force at one side of the aircraft is increased, and through the third rudder and the fourth rudder to generate a roll moment such that the solar unmanned aircraft 100 can perform an axially rolling.

Besides, an internal space of the main wing 13 and the tail wing 14 can be installed with a charge and discharge battery as a power source of the aircraft.

It should be noted that the first propeller 16 and the second propeller 17 are respectively installed at rear end of the first body 11 and the second body 12. Accordingly, when the aircraft intends to pitch up or dive, the control ability of the rudders to the aircraft can be increased. Besides, when the aircraft is landing and sliding on the ground, the vertical control wing will be ripped off, and a net is required to catch the aircraft 100. However, through the above design, the aircraft does not need to fully stop when landing so that the control process is simplified.

Accordingly, through disposing the first vertical control wing 15a, the second vertical control wing 15b, the third vertical control wing 15c and the fourth vertical control wing 15d below the main wing 13 and the tail wing 14, the upper surface of the main wing 13 and the tail wing 14 can be massively installed with solar panels in order to increase an area for installing the solar panels such that the solar unmanned aircraft 100 can stay in the air for a longer time comparing to the conventional art. Besides, using the first rudder 152a, the second rudder 152b, the third rudder 152c and the fourth rudder 152d to respectively rotate with respect to the first fixed wing 151a, the second fixed wing 151b, the third fixed wing 151c and the fourth fixed wing 151d, the solar unmanned aircraft of the present invention can perform any kind of flight motion.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A solar unmanned aircraft, comprising:
a first body having a front end and a rear end;
a second body having a front end and a rear end;
a main wing having an upper surface and a lower surface, wherein the upper surface of the main wing is installed with solar panels, and the lower surface of the main wing is connected with the first body and the second body;
a tail wing having an upper surface and a lower surface, wherein the upper surface of the tail wing is installed with solar panels, and the lower surface of the tail wing is connected with the first body and the second body;
a first vertical control wing disposed below the main wing and having a first fixed wing and a first rudder;
a second vertical control wing disposed below the main wing and having a second fixed wing and a second rudder;
a third vertical control wing disposed below the tail wing and having a third fixed wing and a third rudder;
a fourth vertical control wing disposed below the tail wing and having a fourth fixed wing and a fourth rudder;
a first propeller fixed at the rear end of the first body; and
a second propeller fixed at the rear end of the second body;
wherein, the main wing is disposed between the front ends of the first body and the second body, and the tail wing is disposed between the rear ends of the first body and the second body,
wherein, the first rudder, the second rudder, the third rudder and the fourth rudder are respectively capable of rotating with respect to the first fixed wing, the second fixed wing, the third fixed wing and the fourth fixed wing in order to control the solar unmanned aircraft to yaw, reduce speed, pitch up or dive.

2. The solar unmanned aircraft according to claim 1, wherein at least one of the first vertical control wing, the second vertical control wing, the third vertical control wing and the fourth vertical control wing is connected with the first body or the second body.

3. The solar unmanned aircraft according to claim 2, wherein the first vertical control wing is connected with the first body and corresponding to a connection portion of the main wing and the first body, the second vertical control wing is connected with the second body and corresponding to a connection portion of the main wing and the second body, the third vertical control wing is connected with the first body and corresponding to a connection portion of the tail wing and the first body, and the fourth vertical control wing is connected with the second body and corresponding to a connection portion of the tail wing and the second body.

4. The solar unmanned aircraft according to claim 1, wherein at least one of the first vertical control wing, the second vertical control wing, the third vertical control wing and the fourth vertical control wing is directly connected with the main wing or the tail wing.

5. The solar unmanned aircraft according to claim 1, wherein an end terminal of at least one of the first vertical control wing, the second vertical control wing, the third vertical control wing and the fourth vertical control wing is installed with a sleeve.

6. The solar unmanned aircraft according to claim 1, wherein when the solar unmanned aircraft is yawing, the first rudder is in parallel with the first body, the second rudder is in parallel with the second body, the third rudder and the fourth rudder are rotated together clockwise or counterclockwise with a same angle, and respectively form an included angle with the first body and the second body in order to generate a yaw moment.

7. The solar unmanned aircraft according to claim 1, wherein when the aircraft is reducing the speed or reducing lift force, the first rudder is rotated counterclockwise and forms an included angle with the first body, the second rudder is rotated clockwise and forms an included angle with the second body, the third rudder is rotated clockwise and forms an included angle with the first body, and the fourth rudder is rotated counterclockwise and forms an included angle with the second body so that through the first rudder and the second rudder, a spoiling effect is generated, and through the third rudder and the fourth rudder, direction of the aircraft is controlled and pressing the head of the aircraft.

8. The solar unmanned aircraft according to claim 1, wherein when the head of the aircraft is diving, the first rudder is in parallel with the first body, the second rudder is in parallel with the second body, the third rudder is rotated clockwise and forms an included angle with the first body, the fourth rudder is rotated counterclockwise and forms an included angle with the second body such that a dive moment is generated; when the head of the aircraft is pitching up, the third rudder and the fourth rudder are respectively in parallel with the first body and the second body, the first rudder and the second rudder are rotated with a same angle in opposite directions in order to respectively form an included angle with the first body and the second body, reducing airflow speed under the main wing, so as to generate an upward moment.

9. The solar unmanned aircraft according to claim 1, wherein when the unmanned aircraft performing an axially rolling, the first rudder is rotated counterclockwise or clockwise to form an included angle with the first body, the third rudder is rotated clockwise or counterclockwise in opposite to the first rudder with roughly the same angle, the second rudder is in parallel with the second body, the fourth rudder is in parallel with the second body, to generate a roll moment to life up the first body with respective to the second body.

10. The solar unmanned aircraft according to claim 1, wherein for the other side of roll moment, the second rudder is rotated counterclockwise or clockwise to form an included angle with the second body, the fourth rudder is rotated clockwise or counterclockwise in opposite to the second rudder of roughly the same angle, the first rudder is in parallel with the first body, the third is in parallel with the first body, to generate a roll moment to life up the second body with respective to the first body.

11. The solar unmanned aircraft according to claim 1, wherein the tail wing is capable of providing a horizontal stabilization and providing a lift force to sustain the motor and tail weight respect the gravity center of the aircraft, and using the lift force to generate a pitching control moment

12. The solar unmanned aircraft according to claim 1, wherein an internal space of the main wing and the tail wing is installed with a rechargeable battery as a power storage source of the aircraft.

13. The solar unmanned aircraft according to claim 1, wherein the upper surface of the main wing and the tail wing is installed with solar batteries.

14. The solar unmanned aircraft according to claim 1, wherein the first vertical control wing, the second vertical control wing, the third vertical control wing and the fourth vertical control wing are used as a landing gear of the aircraft.

15. The solar unmanned aircraft according to claim 1, wherein the first propeller fixed at the rear end of the first body; and the second propeller fixed at the rear end of the second body, while lading the aircraft can have some speed and be captured by a prepared net, so as to avoid long runway and to be safe for the retry of landing.
